(19) United States
(12) Patent Application Publication
(10) Pub. No.: US 2026/0270111 A1
(43) Pub. Date: Sep. 10, 2026

(54) COMMUNICATION APPARATUS, COMMUNICATION CONTROL METHOD, AND COMMUNICATION CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takayuki SHIOZAWA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/164,173

(22) PCT Filed: Feb. 26, 2024
(86) PCT No.: PCT/JP2024/006858

§ 371 Date: Sep. 10, 2025

(30) Foreign Application Priority Data
Mar. 13, 2023 (JP) 2023-038479

(51) Int. Cl. H04L 12/40; H04L 47/283

(52) U.S. Cl. CPC H04L 12/4015; H04L 12/40; H04L 47/283; H04L 2012/40215

(57) ABSTRACT

A communication apparatus includes: a determination unit that determines whether a transmission timing of a first frame exceeds a first delay time; a generation unit that generates a stop request frame when it has been determined the transmission timing of the first frame exceeds the first delay time; and an estimation unit that estimates, when it has been determined the transmission timing of the first frame exceeds the first delay time, a transmission timing of a second frame. The determination unit determines whether the transmission timing of the second frame exceeds a second delay time, and the generation unit generates, when it has been determined that the transmission timing of the second frame exceeds the second delay time, the stop request frame for requesting a stopping of transmission of different frames aside from the first and second frames until the first second frames have been transmitted on the communication path.

### CROSS-REFERENCE TO RELATED APPLICATIONS

This application is the U.S. national stage of PCT/JP2024/006858 filed on Feb. 26, 2024, which claims priority of Japanese Patent Application No. JP 2023-038479 filed on Mar. 13, 2023, the contents of which are incorporated herein.

### TECHNICAL FIELD

The present disclosure relates to a communication apparatus, a communication control method, and a communication control program.

### BACKGROUND

Vehicles are equipped with various types of vehicle-mounted apparatuses, such as control system ECUs (Electronic Control Units) that control the engine, transmission, and the like, body system ECUs that control headlights, power windows, and the like, and information system ECUs for navigation apparatuses, multimedia devices, and the like. Such vehicle-mounted apparatuses are connected to a vehicle-mounted network and capable of communicating with each other.

JP 2017-188794A discloses a communication controller that performs arbitration over the transmission of frames based on priority rankings assigned to the frames. The communication controller disclosed in JP 2017-188794A changes a frame, which cannot be transmitted via a communication path even when the tolerated delay time is exceeded due to repeated arbitration losses, into a high-priority frame, acquires transmission rights, and transmits the frame by switching the communication protocol from low-speed CAN (Controller Area Network) to high-speed CAN FD (CAN with Flexible Data Rate).

However, with the communication controller disclosed in JP 2017-188794A, changing the priority ranking of a frame at one ECU may result in the transmission order of a frame sent from another ECU being moved back, which risks the tolerated delay time of that frame being exceeded.

### SUMMARY

A communication apparatus according to an aspect of the present disclosure is a communication apparatus that controls communication on a communication path to which a plurality of vehicle-mounted apparatuses are connected, the communication apparatus including: a determination unit that determines whether a transmission timing of a first frame, out of a scheduled plurality of frames to be transmitted on the communication path, exceeds a first delay time; a generation unit that generates a stop request frame for requesting a stopping of transmission of frames when the determination unit has determined that the transmission timing of the first frame exceeds the first delay time; a transmission unit that transmits the stop request frame generated by the generation unit to the plurality of vehicle-mounted apparatuses via the communication path; and an estimation unit that estimates, when the determination unit has determined that the transmission timing of the first frame exceeds the first delay time, a transmission timing of a second frame whose transmission timing changes due to a change in a transmission order of the first frame, wherein the determination unit determines whether the transmission timing of the second frame estimated by the estimation unit exceeds a second delay time, and the generation unit generates, when the determination unit has determined that the transmission timing of the second frame exceeds the second delay time, the stop request frame for requesting a stopping of transmission of different frames aside from the first frame and the second frame until the first frame and the second frame have been transmitted on the communication path.

### Advantageous Effects

According to an aspect of the present disclosure, it is possible to suppress delays to a plurality of frames transmitted on a communication path.

### BRIEF DESCRIPTION OF DRAWINGS

FIG. 1 is a block diagram depicting an example configuration of a vehicle-mounted system according to an embodiment.

FIG. 2 is a block diagram depicting an example configuration of a relay ECU according to the present embodiment.

FIG. 3 is a block diagram depicting one example configuration of an ECU according to the present embodiment.

FIG. 4 is a functional block diagram depicting example functions of a relay ECU according to the present embodiment.

FIG. 5 is a schematic diagram depicting a frame format for CAN.

FIG. 6 is a diagram schematically depicting example communication in the vehicle-mounted system according to the present embodiment.

FIG. 7 is a diagram depicting one example of a management table.

FIG. 8A is a flowchart depicting a former half of a communication control process performed by the relay ECU according to the present embodiment.

FIG. 8B is a flowchart depicting a latter half of a communication control process performed by the relay ECU according to the present embodiment.

FIG. 9 is a flowchart depicting a communication process performed by an ECU according to the present embodiment.

FIG. 10 is a sequence chart depicting an example operation of the vehicle-mounted system according to the present embodiment.

FIG. 11 is a diagram depicting a modification to the management table.

### DETAILED DESCRIPTION OF PREFERRED EMBODIMENTS

Several embodiments of the present disclosure will first be listed and described in outline.

In a first aspect, a communication apparatus according to an aspect of the present disclosure is a communication apparatus that controls communication on a communication path to which a plurality of vehicle-mounted apparatuses are connected, the communication apparatus including: a determination unit that determines whether a transmission timing of a first frame, out of a scheduled plurality of frames to be transmitted on the communication path, exceeds a first delay time; a generation unit that generates a stop request frame for requesting a stopping of transmission of frames when the determination unit has determined that the transmission timing of the first frame exceeds the first delay time; a transmission unit that transmits the stop request frame generated by the generation unit to the plurality of vehicle-mounted apparatuses via the communication path; and an estimation unit that estimates, when the determination unit has determined that the transmission timing of the first frame exceeds the first delay time, a transmission timing of a second frame whose transmission timing changes due to a change in a transmission order of the first frame, wherein the determination unit determines whether the transmission timing of the second frame estimated by the estimation unit exceeds a second delay time, and the generation unit generates, when the determination unit has determined that the transmission timing of the second frame exceeds the second delay time, the stop request frame for requesting a stopping of transmission of different frames aside from the first frame and the second frame until the first frame and the second frame have been transmitted on the communication path. By doing so, it is possible to estimate the transmission timing of the second frame, whose transmission order has been moved back due to the first frame being transmitted with priority and when the transmission timing exceeds the second delay time, the second frame is also transmitted with priority. Accordingly it is possible to suppress a delay to the second frame in addition to the first frame.

In a second aspect, in the communication apparatus according to the first aspect, the estimation unit may estimate, as the transmission timing of the second frame, a timing produced by adding a time required for transmission of the stop request frame and the first frame to a transmission timing of the second frame before the transmission order of the first frame is changed. By doing so, it is possible to correctly estimate the transmission timing of the second frame.

In a third aspect, in the communication apparatus according to the first or the second aspect, the generation unit may generate, when the determination unit has determined that the transmission timing of the second frame exceeds the second delay time, the stop request frame including first identification information for identifying the first frame and second identification information for identifying the second frame. By doing so, it is possible for a vehicle-mounted apparatus that has received the stop request frame to identify that the frames to be transmitted with priority are the first frame and the second frame.

In a fourth aspect, in the communication apparatus according to the third aspect, the stop request frame may include the first identification information and the second identification information in a transmission order of the first frame and the second frame. By doing so, it is possible for the vehicle-mounted apparatus that receives the stop request frame to recognize the transmission order of the first frame and the second frame.

In a fifth aspect, in the communication apparatus according to any one of the first to the fourth aspects, the first delay time may be set based on a first tolerated delay time, which is a tolerated delay time for the first frame, and one of a number of pieces of identification information of frames transmitted on the communication path, a number of the vehicle-mounted apparatuses connected to the communication path, and a transmission frequency of frames on the communication path, and the second delay time may be set based on a second tolerated delay time, which is a tolerated delay time for the second frame, and one of the number of pieces of identification information of frames transmitted on the communication path, the number of the vehicle-mounted apparatuses connected to the communication path, and the transmission frequency of frames on the communication path. By doing so, it is possible to rationally set the first delay time and the second delay time.

In a sixth aspect, in the communication apparatus according to any one of the first to the fifth aspects, the first delay time may be set based on whether a transmission source of the first frame is a vehicle-mounted apparatus connected to one communication path or a vehicle-mounted apparatus connected to a plurality of communication paths, and the second delay time may be set based on whether the transmission source of the second frame is a vehicle-mounted apparatus connected to one communication path or a vehicle-mounted apparatus connected to a plurality of communication paths. By doing so, it is possible to rationally set the first delay time and the second delay time.

In a seventh aspect, in the communication apparatus according to any one of the first to the sixth aspects, the communication apparatus may be a relay apparatus that is connected to a plurality of communication paths and relays frames between the plurality of communication paths. By doing so, it is possible for a relay apparatus that transmits and receives many frames to collectively control the communication of frames on each communication path.

In an eighth aspect, in the communication apparatus according to the seventh aspect, the determination unit may also determine whether a retention time at the relay apparatus of the first frame transmitted from a first communication path to a second communication path out of the plurality of communication paths exceeds a threshold, and the generation unit may generate the stop request frame when the determination unit has determined that the transmission timing of the first frame exceeds the first delay time or that the retention time exceeds the threshold. By doing so, it is possible to determine whether frame transmission will be delayed not only due to the transmission timing of frames but also due to retention at a relay apparatus.

In a ninth aspect, in the communication apparatus according to the eighth aspect, the estimation unit may also estimate, when the second frame is a frame to be transmitted from the first communication path to the second communication path, a retention time of the second frame at the relay apparatus when a transmission order of the first frame has changed, the determination unit may also determine whether the retention time of the second frame estimated by the estimation unit exceeds the threshold, and the generation unit may generate, when the determination unit has determined that the transmission timing of the second frame exceeds the second delay time or the retention time of the second frame exceeds the threshold, the stop request frame for requesting a stopping of transmission of different frames aside from the first frame and the second frame until the first frame and the second frame have been transmitted on the communication path. By doing so, it is possible to estimate the retention time of the second frame, whose transmission order has been moved back due to the first frame being transmitted with priority, at the relay apparatus and if the retention time exceeds a threshold, the second frame is also transmitted with priority. Accordingly, delays caused by the second frame being retained at the relay apparatus can be suppressed.

In a tenth aspect, in the communication apparatus according to the ninth aspect, the estimation unit may estimate, as the retention time of the second frame, a time obtained by adding a time required for transmission of the stop request frame and the first frame to a retention time at the relay apparatus of the second frame before a transmission order of the first frame is changed. By doing so, it is possible to correctly estimate the retention time of the second frame.

In an eleventh aspect, in the communication apparatus according to any one of the first to the tenth aspects, the communication apparatus may further include a switching unit that switches between a first communication protocol and a second communication protocol that has a higher transmission speed than the first communication protocol, and the switching unit may switch from the first communication protocol to the second communication protocol during a period from when the stop request frame is transmitted until transmission of the first frame and the second frame is completed. By doing so, it is possible to transmit the first and second frames, which have been moved forward in the transmission order, at a high transmission speed using the second communication protocol.

In a twelfth aspect, a communication control method according to an aspect of the present disclosure is a communication control method that controls communication on a communication path to which a plurality of vehicle-mounted apparatuses are connected, the communication method including: a step of determining whether a transmission timing of a first frame, out of a scheduled plurality of frames to be transmitted on the communication path, exceeds a first delay time; a step of estimating, when it has been determined that the transmission timing of the first frame exceeds the first delay time, a transmission timing of a second frame whose transmission timing changes due to a change in a transmission order of the first frame; a step of determining whether the estimated transmission timing of the second frame exceeds a second delay time; a step of generating, when it has been determined by the determination unit that the transmission timing of the second frame exceeds the second delay time, a stop request frame for requesting a stopping of transmission of different frames aside from the first frame and the second frame until the first frame and the second frame have been transmitted on the communication path; and a step of transmitting the generated stop request frame via the communication path to the plurality of vehicle-mounted apparatuses. By doing so, it is possible to estimate the transmission timing of the second frame, whose transmission order has been moved back due to the first frame being transmitted with priority, and when the transmission timing exceeds the second delay time, the second frame is also transmitted with priority. Accordingly, it is possible to suppress a delay to the second frame in addition to the first frame.

In a thirteenth aspect, a communication control program according to an aspect of the present disclosure is a communication control program for controlling communication on a communication path to which a plurality of vehicle-mounted apparatuses are connected, the communication control program causing a computer to execute a process including: a step of determining whether a transmission timing of a first frame, out of a scheduled plurality of frames to be transmitted on the communication path, exceeds a first delay time; a step of estimating, when it has been determined that the transmission timing of the first frame exceeds the first delay time, a transmission timing of a second frame whose transmission timing changes due to a change in a transmission order of the first frame; a step of determining whether the estimated transmission timing of the second frame exceeds a second delay time; a step of generating, when it has been determined by the determination unit that the transmission timing of the second frame exceeds the second delay time, a stop request frame for requesting a stopping of transmission of different frames aside from the first frame and the second frame until the first frame and the second frame have been transmitted on the communication path; and a step of transmitting the generated stop request frame via the communication path to the plurality of vehicle-mounted apparatuses. By doing so, it is possible to estimate the transmission timing of the second frame, whose transmission order has been moved back due to the first frame being transmitted with priority, and when the transmission timing exceeds the second delay time, the second frame is also transmitted with priority. Accordingly, it is possible to suppress a delay to the second frame in addition to the first frame.

The present disclosure can be realized not only as a communication apparatus with the characteristic configuration described above, a communication control method including steps corresponding to characteristic processing in this communication apparatus, and a communication control program for causing a communication apparatus to execute such characteristic processing, but also as a vehicle-mounted system including the communication apparatus or as a semiconductor integrated circuit in which part or all of the communication apparatus is implemented.

Preferred embodiments of the present disclosure are described in detail below with reference to the accompanying drawings. Note that the embodiments described below can be freely combined, at least in part.

### Vehicle-Mounted System

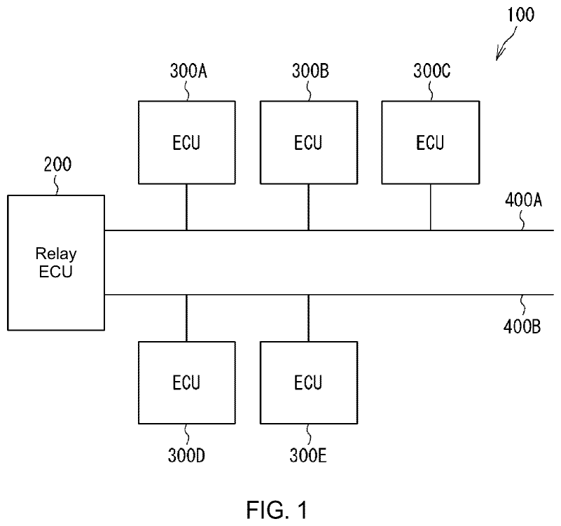

FIG. 1 is a block diagram depicting an example configuration of a vehicle-mounted system according to the present embodiment. The vehicle-mounted system 100 is mounted in a vehicle.

The vehicle-mounted system 100 according to the present embodiment includes a relay ECU 200 and ECUs 300A, 300B, 300C, 300D, and 300E. The vehicle-mounted system 100 is a vehicle-mounted network constructed by the relay ECU 200, the ECUs 300A, 300B, 300C, 300D, and 300E, and communication lines (communication buses) that connect such devices.

The plurality of ECUs 300A, 300B, 300C, 300D, and 300E are disposed in various parts of the vehicle. The ECUs 300A, 300B, 300C, 300D, and 300E individually control hardware at each part of the vehicle and/or monitor the status of the hardware at each part of the vehicle. As one example, the ECUs 300A, 300B, 300C, 300D, and 300E are ECUs for a control system, a body system, and an information system. The ECUs 300A, 300B, 300C, 300D, and 300E are examples of “vehicle-mounted apparatuses” for the present disclosure. Note that in the following description, the ECUs 300A, 300B, 300C, and 300D are also collectively referred to as the “ECUs 300.”

The relay ECU 200 is connected to the ECUs 300A, 300B, 300C, 300D, and 300E via communication buses 400A and 400B. The communication buses 400A and 400B are CAN buses, for example. In more detail, the ECUs 300A, 300B, and 300C are connected to the bus 400A. The ECUs 300D and 300E are connected to the bus 400B. The relay ECU 200 is capable of bidirectional communication with each of the ECUs 300A, 300B, 300C, 300D, and 300E.

The relay ECU 200 and the ECUs 300 use a first communication protocol for cyclically or non-cyclically transmitting and receiving messages. The first communication protocol is CAN, for example. The relay ECU 200 and the ECUs 300 can also use a second communication protocol with a higher transmission speed than the first communication protocol. This second communication protocol is CAN FD (CAN with Flexible Data Rate), for example. As another example, the second communication protocol may be CAN XL. In the present embodiment, an example where the first communication protocol is CAN and the second communication protocol is CAN FD will be described.

The relay ECU 200 functions as a gateway that relays communication between a plurality of ECUs 300. The ECUs 300 are capable of transmitting frames. The relay ECU 200 relays frames between ECUs connected to different buses. As one example, the relay ECU 200 can relay frames between the ECU 300A connected to the bus 400A and the ECU 300D connected to the bus 400B.

### Configuration of Relay ECU

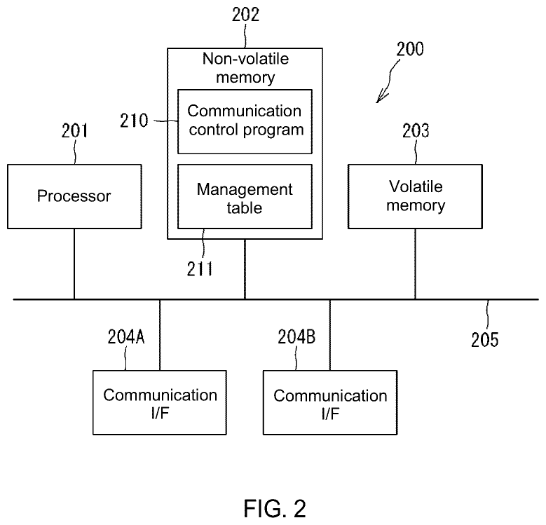

FIG. 2 is a block diagram depicting an example configuration of a relay ECU according to the present embodiment. The relay ECU 200 includes a processor 201, a non-volatile memory 202, a volatile memory 203, and communication interfaces (hereinafter also referred to as “communication I/F”) 204A and 204B. The relay ECU 200 is one example of a “communication apparatus” for the present disclosure. In more detail, the relay ECU 200 is one example of a “relay apparatus”. The processor 201, the non-volatile memory 202, the volatile memory 203, and the communication I/Fs 204A and 204B are connected to each other via a bus 205, which is a communication line. The processor 201, the non-volatile memory 202, the volatile memory 203, and the communication I/Fs 204A and 204B can transmit data to each other via this bus 205.

As one example, the volatile memory 203 is a semiconductor memory such as a static random access memory (SRAM) or a dynamic random access memory (DRAM). As examples, the non-volatile memory 202 is a flash memory, a hard disk, or a read only memory (ROM). The non-volatile memory 202 stores a communication control program 210, which is a computer program, and data used to execute the communication control program 210. The functions of the relay ECU 200, which will be described later, are realized by the processor 201 executing the communication control program 210.

As one example, the processor 201 is a central processing unit (CPU). However, the processor 201 is not limited to a CPU and may be a graphics processing unit (GPU). As a specific example, the processor 201 is a multi-core processor. However, the processor 201 may be a single-core processor. The processor 201 is configured to be capable of executing a computer program. However, as other examples, the processor 201 may be an ASIC (Application Specific Integrated Circuit) or a programmable logic device such as an FPGA(Field Programmable Gate Array). In this case, the ASIC or the programmable logic device is configured to be capable of executing the same functions as the communication control program 210.

The communication I/Fs 204A and 204B are communication interfaces that conform to the first and second communication protocols described above, and as one example are CAN interfaces.

The communication I/F 204A is connected to the bus 400A. The communication I/F 204B is connected to the bus 400B. The relay ECU 200 can communicate with the ECUs 300A, 300B, and 300C via the communication I/F 204A. The relay ECU 200 can communicate with the ECUs 300D and 300E via the communication I/F 204B.

The non-volatile memory 202 stores a management table 211. The management table 211 is used by the communication control program 210. The management table 211 will be described later.

### Configuration of ECU

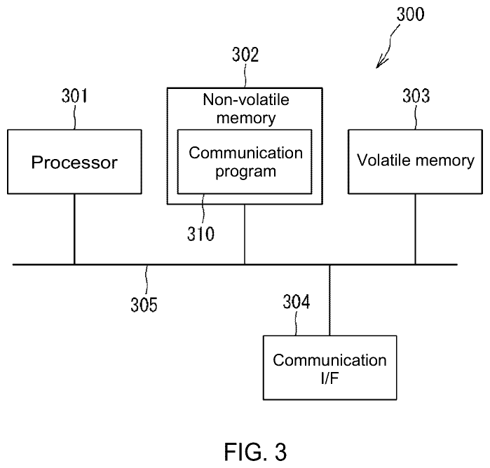

FIG. 3 is a block diagram depicting one example configuration of an ECU according to the present embodiment. Each ECU 300 includes a processor 301, a non-volatile memory 302, a volatile memory 303, and a communication I/F 304. The processor 301, the non-volatile memory 302, the volatile memory 303, and the communication I/F 304 are connected to each other by a bus 305, which is a communication line. The processor 301, the non-volatile memory 302, the volatile memory 303, and the communication I/F 304 can transmit data to each other via the bus 305.

As one example, the volatile memory 303 is a semiconductor memory, such as SRAM or DRAM. As examples, the non-volatile memory 302 is a flash memory, a hard disk drive, or a ROM. The non-volatile memory 302 stores a communication program 310, which is a computer program, and data used to execute the communication program 310. The functions of the ECU 300 described later are realized by the processor 301 executing the communication program 310.

The processor 301 is a CPU, for example. However, the processor 301 is not limited to a CPU and may be a GPU. As a specific example, the processor 301 is a multi-core processor. However, the processor 301 may be a single-core processor. The processor 301 is configured to be capable of executing a computer program. However, as other examples, the processor 301 may be an ASIC or a programmable logic device, such as an FPGA. In this case, the ASIC or the programmable logic device is configured to be capable of executing the same functions as the communication program 310.

The communication I/F 304 is a communication interface that conforms to the first and second communication protocols described above. As one example, the communication I/F 304 is a CAN interface.

The communication I/F 304 is connected to the bus 400. The ECU 300 can communicate with the ECUs 300 and the relay ECU 200 via this communication I/F 304.

### Functions of Relay ECU

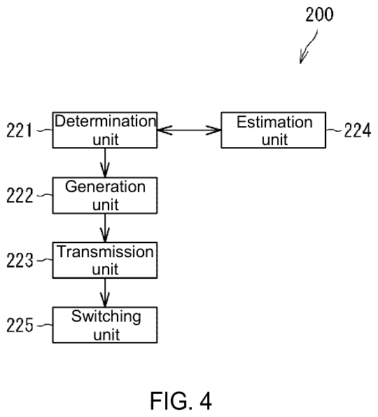

FIG. 4 is a functional block diagram depicting example functions of a relay ECU according to the present embodiment.

The processor 201 of the relay ECU 200 executes the communication control program 210 to realize the functions of a determination unit 221, a generation unit 222, a transmission unit 223, an estimation unit 224, and a switching unit 225. That is, the determination unit 221, the generation unit 222, the transmission unit 223, the estimation unit 224, and the switching unit 225 are each realized by the processor 201.

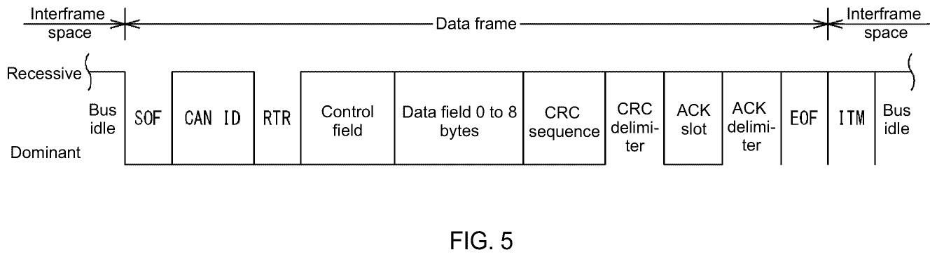

FIG. 5 is a schematic diagram depicting a frame format for CAN. FIG. 5 depicts the data frame structure of the CAN standard format. The upper line in the drawing indicates “recessive” and the lower line indicates “dominant”. As depicted in FIG. 5, a CAN data frame includes the following fields: SOF (Start Of Frame); CAN ID; RTR (Remote Transmission Request); control field; data field; CRC (Cyclic Redundancy Check) sequence; CRC delimiter; ACK (Acknowledgement) slot; ACK delimiter; and EOF (End Of Frame). SOF indicates the start of the frame. CAN ID is used to identify the ECU and the type of frame. RTR is used to distinguish between data frames and remote frames. For data frames, RTR is dominant. The control field stores information used for communication control. The data field stores a maximum of 8 bytes of actual data (known as the “payload”). The CRC sequence and CRC delimiter are collectively referred to as the “CRC field”, in which a type of error detection code is stored. The ACK slot and ACK delimiter are collectively referred to as the “ACK field”, in which information indicating whether the CRC field part was received normally is stored. EOF indicates the end of the frame.

According to CAN, each frame contains identification information called a “CAN ID”. The CAN ID indicates the type of frame. As examples, the CAN ID of a frame containing “engine RPM” data is “0x100” and the CAN ID of a frame containing “accelerator position” data is “0x200”.

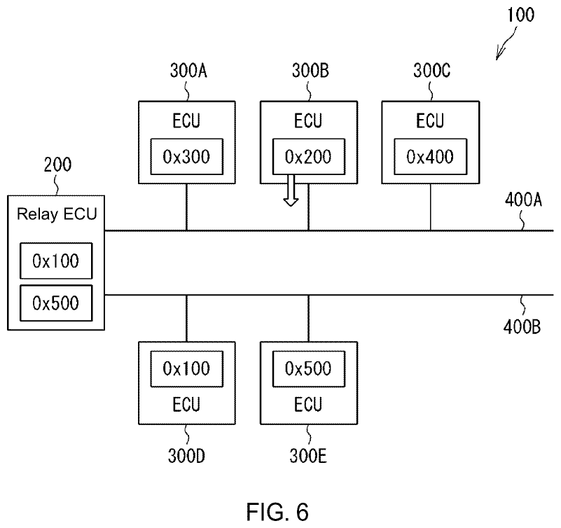

The CAN ID also indicates the transmission source of a frame. FIG. 6 is a diagram schematically depicting example communication in the vehicle-mounted system 100 according to the present embodiment. In FIG. 6, a five-digit hexadecimal number starting with 0x, such as “0x100”, indicates a CAN ID, and a rectangle including a CAN ID indicates a frame. In the example in FIG. 6, the CAN ID of a frame transmitted from the ECU 300A is “0x300”, the CAN ID of a frame transmitted from the ECU 300B is “0x200”, the CAN ID of a frame transmitted from the ECU 300C is “0x400”, the CAN ID of a frame transmitted from the ECU 300D is “0x100”, and the CAN ID of a frame transmitted from the ECU 300E is “0x500”.

Each of the communication buses 400A and 400B transmits frames sequentially. The communication buses 400A and 400B are both incapable of transmitting a plurality of frames simultaneously. In other words, while single frames are being transferred on the communication buses 400A and 400B, the communication buses 400A and 400B are occupied by those frames.

In the example in FIG. 6, a frame with the CAN ID 0x200 is sent from the ECU 300B to the communication bus 400A. Accordingly, during the period while the frame with the CAN ID 0x200 is being transferred on the communication bus 400A, other frames cannot be transferred.

The relay ECU 200 relays frames between the communication buses 400A and 400B. In the example in FIG. 6, the relay ECU 200 relays a frame with the CAN ID 0x100 transmitted from the ECU 300D and a frame with the CAN ID 0x500 transmitted from the ECU 300E from the communication bus 400B to the communication bus 400A. In the example in FIG. 6, the relay ECU 200 is yet to send a frame with the CAN ID 0x100 and the CAN ID 0x500 received from the communication bus 400B to the communication bus 400A, so that the frame with the CAN ID 0x100 and the frame with the CAN ID 0x500 are held in an internal buffer.

CAN IDs also indicate priorities used in communication arbitration. The lower the CAN ID, the higher the priority. That is, in the example in FIG. 6, the priority decreases in the order of 0x100, 0x200, 0x300, 0x400, and then 0x500. Accordingly after the frame with the CAN ID 0x200 has been transmitted on the communication bus 400A, frames are scheduled to be transmitted sequentially on the communication bus 400A in the order 0x100, 0x300, 0x400, and 0x500.

However, there are also cases where another frame will interrupt before all of the frames with the CAN IDs 0x100, 0x300, 0x400, and 0x500 have been transmitted. As one example, if a frame with the CAN ID 0x200 is transmitted again to the communication bus 400A after the frame with the CAN ID 0x300 has been transmitted, the frames with CAN IDs 0x400 and 0x500 will stand by due to arbitration loss. Accordingly there is the risk of frames with low priority, for example, frames with the CAN IDs 0x400 and 0x500, continuing to lose in arbitration and being delayed beyond a tolerated range. The relay ECU 200 according to the present embodiment suppresses delays to frame due to arbitration losses like this.

Returning to FIG. 4, the determination unit 221 determines whether the transmission timing of a frame out of a plurality of frames scheduled for transmission on the communication buses 400A and 400B exceeds a first delay time.

In CAN, both frames that are cyclically transmitted and frames that are transmitted non-cyclically exist. For frames that are transmitted cyclically, the frame transmission interval (reception interval) is determined for each CAN ID. As a specific example, the determination unit 221 determines whether the transmission timing exceeds a first delay time by determining whether an elapsed time since the last time a frame with the same CAN ID was received (hereinafter simply referred to as the “elapsed time”) exceeds a first threshold corresponding to the first delay time. Hereinafter, a frame for which the elapsed time is to be compared with the first threshold is also referred to as the “first frame”.

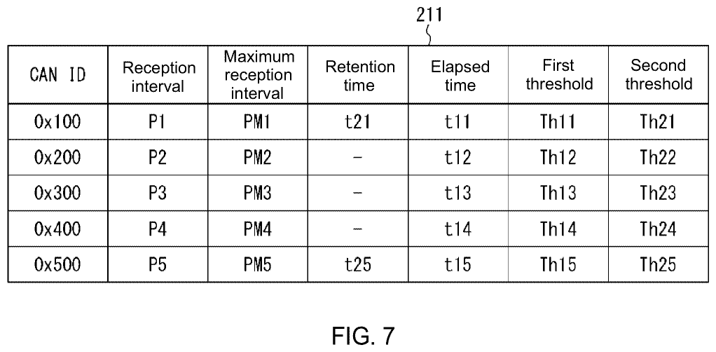

The relay ECU 200 controls communication in the vehicle-mounted system 100 by using a management table 211 for example. FIG. 7 is a diagram depicting one example of the management table. The management table 211 is a table for managing the communication state of frames with each CAN ID.

The management table 211 has CAN ID, reception interval, maximum reception interval, retention time, elapsed time, first threshold, and second threshold columns, and includes a record (row) for each CAN ID. The management table 211 registers a reception interval, a maximum reception interval, a retention time, an elapsed time, a first threshold, and a second threshold for each CAN ID.

The reception interval, maximum reception interval, first threshold, and second threshold are fixed values. The reception interval is a frame reception interval that is specified for each CAN ID. The maximum reception interval is a limit value for which a delay exceeding the reception interval of one frame is tolerated. In the example in FIG. 7, the reception interval for the CAN ID 0x100 is P1, and the maximum reception interval is PM1. The reception interval for CAN ID 0x200 is P2, and the maximum reception interval is PM2. The reception interval for CAN ID 0x300 is P3, and the maximum reception interval is PM3. The reception interval for CAN ID 0x400 is P4, and the maximum reception interval is PM4. The reception interval for CAN ID 0x500 is P5, and the maximum reception interval is PM5.

The retention time and the elapsed time are values that are updated successively as time passes. The management table 211 is updated in real time at predetermined intervals. This means that the retention time and the elapsed time are updated at predetermined intervals.

The retention time is the time for which the relay ECU 200 has currently held a frame. In other words, the retention time is the time that has elapsed since the relay ECU 200 received that frame. The retention time is set at “0” when the relay ECU 200 has received a frame to be relayed from the communication bus 400B to the communication bus 400A, and increases as time passes. The retention time is deleted from the management table 211 when the relay ECU 200 transmits the frame.

The retention time is set only for the CAN ID of a frame being relayed by the relay ECU 200. In the example in FIG. 7, the retention time for the CAN ID 0x100 is t21. The retention time for the CAN ID 0x500 is t25. A retention time is not set for the CAN IDs 0x200, 0x300, and 0x400.

The elapsed time is the time that has elapsed since the relay ECU 200 (and the ECUs 300A, 300B, 300C, 300D, and 300E) last received a frame with the CAN ID in question. The elapsed time is set at “0” when the relay ECU 200 receives a frame with the CAN ID in question, and increases as time passes. The elapsed time is reset when the relay ECU 200 receives the next frame with that CAN ID.

An elapsed time is set for each CAN ID. In the example in FIG. 7, the elapsed time for the CAN ID 0x100 is t11. The elapsed time for the CAN ID 0x200 is t12. The elapsed time for the CAN ID 0x300 is t13. The elapsed time for the CAN ID 0x400 is t14. The elapsed time for the CAN ID 0x500 is t15.

The first threshold is a threshold for the elapsed time. The first threshold is set for each CAN ID. In the example in FIG. 7, the first threshold corresponding to the CAN ID 0x100 is Th11. The first threshold corresponding to the CAN ID 0x200 is Th12. The first threshold corresponding to the CAN ID 0x300 is Th13. The first threshold corresponding to the CAN ID 0x400 is Th14. The first threshold corresponding to the CAN ID 0x500 is Th15.

As described earlier, the first threshold corresponds to the first delay time. The maximum reception interval is the tolerated delay time of a frame. The first threshold, that is, the first delay time, is set within a range where the elapsed time does not exceed the maximum reception interval. In more detail, the first threshold is set at a value that is larger than the reception interval and smaller than the maximum reception interval.

If a frame has not been transmitted even though the reception interval has elapsed since the transmission (reception) of the previous frame, that is, if the transmission of a frame has been delayed, transmission of such frame is requested to prevent the maximum reception interval from being exceeded. When it is assumed that the current time is the earliest possible transmission timing of the frame, if the current time exceeds the first delay time, there is a risk of the transmission timing of the frame exceeding the maximum reception period. Returning to FIG. 4, the determination unit 221 determines whether the elapsed time exceeds the first threshold and thereby determines whether the transmission timing of a frame will exceed the first delay time. In other words, if the elapsed time currently exceeds the first threshold, there is a risk of the transmission timing of the frame exceeding the maximum reception period.

The first threshold is set based on the maximum reception interval. As one example, the first threshold can be set based on the maximum reception interval and also the number of CAN IDs of frames transmitted on the communication buses 400A and 400B. When the number of CAN IDs of frames transferred on the communication buses 400A and 400B is large, it is expected that frames whose CAN IDs are large will suffer consecutive arbitration losses. For this reason, the larger the number of CAN IDs of frames transmitted on the communication buses 400A and 400B, the smaller the value set as the first threshold.

As one example, the first threshold can be set based on the maximum reception interval and also on the number of ECUs 300 connected to the communication buses 400A and 400B. If many ECUs are connected to the communication buses 400A and 400B, it is expected that the number of frames transmitted on the communication buses 400A and 400B will increase and that frames whose CAN IDs are large will suffer consecutive arbitration losses. For this reason, the larger the number of ECUs connected to the communication buses 400A and 400B, the smaller the value that can be set as the first threshold.

As another example, the first threshold can be set based on the maximum reception interval and also the transmission frequency of frames on the communication buses 400A and 400B. That is, if the transmission frequency of frames on the communication buses 400A and 400B is high, the number of frames transmitted on the communication buses 400A and 400B will increase, so that it is expected that frames whose CAN IDs are large will suffer consecutive arbitration losses. For this reason, the higher the transmission frequency of frames on the communication buses 400A and 400B, the smaller the value that can be set as the first threshold.

As another example, the first threshold may be set based on the maximum reception interval and also on whether the transmission source of a frame with a corresponding CAN ID is a vehicle-mounted apparatus connected to one communication bus 400A, that is, whether the transmission source is an ECU 300, or whether the transmission source is a vehicle-mounted apparatus connected to a plurality of communication buses 400A and 400B, that is, whether the transmission source is the relay ECU 200. In some cases, a plurality of frames are retained at the relay ECU 200. When this happens and a frame to be transmitted first has been retained, it is expected that the retention time of a frame to be transmitted later will increase. Accordingly, it is preferable to reduce the retention times of frames at the relay ECU 200. For this reason, a small value can be set as the first threshold for CAN IDs for which the transmission source of the frame is the relay ECU 200, and a larger value can be set as the first threshold for CAN IDs for which the transmission source of the frame is an ECU 300.

When the determination unit 221 has determined that the elapsed time exceeds the first threshold, that is, when the determination unit 221 determines that the transmission timing of a frame exceeds the first delay time, the generation unit 222 generates a stop request frame to request that transmission of frames is to stop.

The generation unit 222 determines that a frame with a CAN ID whose elapsed time has been determined to exceed the first threshold is a priority frame, which is a frame to be transmitted with priority. The payload of a stop request frame includes the CAN IDs of priority frames. The stop request frame is a frame that requests a stopping of frames aside from the priority frames.

The stop request frame is assigned a CAN ID that is smaller than the smallest CAN ID in the vehicle-mounted system. As one example, the CAN ID of the stop request frame is set at the smallest CAN ID out of the CAN IDs that can be assigned in the vehicle-mounted system. As examples, the CAN ID of the stop request frame is set at “0x000” or “0x001”. By doing so, the priority of the stop request frame is higher than the priorities of other frames. The transmission unit 223 transmits the stop request frame generated by the generation unit 222 to the ECUs 300A, 300B, and 300C via the communication bus 400A. The ECUs 300A, 300B, and 300C that have received a stop request frame stop transmitting frames aside from the priority frames until a frame with the CAN ID designated in the stop request frame is received. If an ECU 300A, 300B, or 300C is holding a frame with a CAN ID determined to be a target for priority transmission, such ECU will transmit the priority frame when a stop request frame is received. By doing so, priority frames are transmitted before frames with other CAN IDs.

As a result of the priority frames being transmitted before other frames, it is conceivable that some other frames (that is, frames whose transmission is delayed due to the priority frames) will be transmitted even if the maximum reception interval is exceeded (that is, frames whose transmission suffers a secondary delay). The relay ECU 200 according to the present embodiment controls the transmission order of frames so that there are no frames for which a secondary transmission delay occurs.

When the determination unit 221 has determined that the transmission timing of a first frame will exceed the first delay time, the estimation unit 224 estimates the transmission timing of frames whose transmission timing will change due to a change in the transmission order of the first frame. Hereinafter, the transmission timing estimated by the estimation unit 224 is also referred to as the “expected transmission timing”. As one example, the estimation unit 224 determines the expected transmission timing of a frame based on the delay time caused by the transmission of the priority frame. Hereinafter, a frame for which the expected transmission timing is determined is also referred to as a “second frame”.

As a specific example, the estimation unit 224 can determine the expected transmission timing of the second frame as a timing produced by adding the time required for transmission of the stop request frame and the first frame to the transmission timing of the second frame before the transmission order of the first frame (a priority frame) is changed.

As one example, the estimation unit 224 can calculate the transmission time of the stop request frame based on the data size of the stop request frame and the transmission speed on the communication buses 400A and 400B. The estimation unit 224 can calculate the transmission time of the priority frame based on the data size of the priority frame and the transmission speed on the communication buses 400A and 400B. The estimation unit 224 can calculate the delay time caused by the transmission of the priority frame by adding up the transmission time of the stop request frame, the transmission time of the priority frame, and the interval between frames (for two transmissions).

The estimation unit 224 calculates the expected elapsed time by adding the calculated delay time to the elapsed time of each CAN ID (excluding CAN IDs determined to be priority frames). Frames of CAN IDs aside from the priority frames will be transmitted at the expected elapsed time or later. Accordingly, the expected elapsed time is the earliest possible timing from the current time at which a frame can be transmitted. The expected elapsed time is one example of an estimated transmission timing.

The determination unit 221 determines whether the expected transmission timing of the second frame determined by the estimation unit 224 exceeds a second delay time. As a specific example, the determination unit 221 determines whether the expected elapsed time exceeds a first threshold, and thereby determines whether the transmission timing exceeds the second delay time. In the same way as the first delay time described above, the first threshold corresponds to the second delay time.

When the determination unit 221 has determined that the expected transmission timing of the second frame will exceed the second delay time, the generation unit 222 generates a stop request frame to request the stopping of transmission of frames until the first frame and the second frame have been transmitted to the communication buses 400A and 400B.

The generation unit 222 determines, as a priority frame, a frame with a CAN ID for which it has been determined that the expected elapsed time exceeds the first threshold. The payload of the stop request frame includes the CAN IDs of priority frames, that is, the CAN ID of the first frame for which it has been determined that the elapsed time exceeds the first threshold, as well as the CAN ID of the second frame for which it has been determined that the expected elapsed time exceeds the first threshold. In a more specific example, the payload of the stop request frame contains the CAN IDs in the transmission order of the first frame and the second frame. As one example, if the CAN ID determined to have an elapsed time that exceeds the first threshold is 0x400, and the CAN ID determined to have an expected elapsed time that exceeds the first threshold is 0x500, the payload of the stop request frame will contain 0x400 and 0x500 in that order.

It is desirable for the retention time of a frame at the relay ECU 200 to be short, and it is necessary for frames to be transmitted within a tolerated retention time. The determination unit 221 can further determine whether the retention time at the relay ECU 200 of a first frame to be transmitted from the communication bus 400B to the communication bus 400A out of the plurality of communication buses 400A and 400B exceeds a second threshold.

The second threshold is a threshold for the retention time. The second threshold is set for each CAN ID. In the example in FIG. 7, the second threshold that corresponds to the CAN ID 0x100 is Th21. The second threshold corresponding to the CAN ID 0x200 is Th22. The second threshold corresponding to the CAN ID 0x300 is Th23. The second threshold corresponding to the CAN ID 0x400 is Th24. The second threshold corresponding to the CAN ID 0x500 is Th25.

The second threshold is set based on the tolerated retention time at the relay ECU 200. In more detail, the second threshold is set at a value that is less than or equal to the tolerated retention time.

Returning to FIG. 4, the generation unit 222 can generate a stop request frame not only when the elapsed time corresponding to a CAN ID exceeds the first threshold but also when the determination unit 221 has determined that the retention time exceeds the second threshold.

The generation unit 222 can determine that a frame with a CAN ID whose retention time has been determined to exceed the second threshold is a priority frame, that is, a frame to be transmitted with priority. The payload of the stop request frame includes the CAN ID of this priority frame.

When the second frame is a frame to be transmitted from the communication bus 400B to the communication bus 400A, the estimation unit 224 can estimate the retention time of the second frame at the relay ECU 200 for a case where the transmission order of the first frame has changed. Hereinafter, the retention time estimated by the estimation unit 224 is also referred to as the “expected retention time”. As one example, the estimation unit 224 determines the expected retention time of the second frame based on the delay time caused by the transmission of the priority frame.

As a specific example, the estimation unit 224 can determine the expected retention time of the second frame as a time produced by adding the time required for transmission of the stop request frame and the first frame to the retention time of the second frame before the transmission order of the first frame (a priority frame) is changed.

As one example, the estimation unit 224 determines the expected retention time of the second frame as the retention time of the second frame at the relay ECU 200 before the transmission order of the first frame (the priority frame) is changed, plus the time required by transmission of the stop request frame and the priority frame. As described earlier, the estimation unit 224 can calculate the delay time due to the transmission of the priority frame by adding the transmission time of the stop request frame, the transmission time of the priority frame, and the interval between frames. The estimation unit 224 calculates the expected retention time by adding the calculated delay time to the retention time of each CAN ID (excluding CAN IDs determined to be priority frames).

The determination unit 221 can further determine whether the expected retention time of the second frame determined by the estimation unit 224 exceeds a second threshold.

When the determination unit 221 has determined that the expected retention time of the second frame exceeds the second threshold, the generation unit 222 generates a stop request frame to request a stopping of transmission of frames until the first frame and the second frame have been transmitted to the communication buses 400A and 400B.

The generation unit 222 determines, as a priority frame, a frame with a CAN ID whose expected retention time has been determined to exceed the second threshold. The payload of the stop request frame includes the CAN IDs of priority frames, that is, at least one of the CAN ID of a first frame whose elapsed time has been determined to exceed the first threshold and the CAN ID of a first frame whose retention time has been determined to exceed the second threshold, and also the CAN ID of the second frame whose expected retention time has been determined to exceed the second threshold. As described above, as one example, the payload of the stop request frame contains the CAN IDs in the transmission order of the first and second frames. As one example, if a CAN ID determined to have an elapsed time that exceeds the first threshold is 0x400 and a CAN ID determined to have an expected retention time that exceeds the second threshold is 0x500, the payload of the stop request frame will contain 0x400 and 0x500 in that order.

The switching unit 225 switches between the first communication protocol and the second communication protocol. The switching unit 225 switches from the first communication protocol to the second communication protocol during a period from transmission of a stop request frame to completion of transmission of the priority frames.

The stop request frame is transmitted using the low-speed first communication protocol. Reception of the stop request frame triggers switching from the first communication protocol to the second communication protocol. When the stop request frame has been transmitted, the relay ECU 200 switches from the first communication protocol to the second communication protocol. When a stop request frame has been received, each ECU 300 switches from the first communication protocol to the second communication protocol.

The priority frames are transmitted using the high-speed second communication protocol. The priority frames are generated in a format that conforms with the second communication protocol. Reception of the priority frames triggers switching from the second communication protocol to the first communication protocol. When every priority frame has been transmitted, the relay ECU 200 switches from the second communication protocol to the first communication protocol. When every priority frame has been received, each ECU 300 switches from the second communication protocol to the first communication protocol.

The estimation unit 224 can calculate the transmission time of the stop request frame based on the transmission speed of the first communication protocol. If the first communication protocol is CAN, the transmission speed is 500 kbps, for example. The estimation unit 224 can calculate the transmission time of the priority frames based on the transmission speed of the second communication protocol. If the second communication protocol is CAN FD, the transmission speed is 1 Mbps, for example.

### Operation of Vehicle-Mounted System

The operation of the vehicle-mounted system according to the present embodiment is described below.

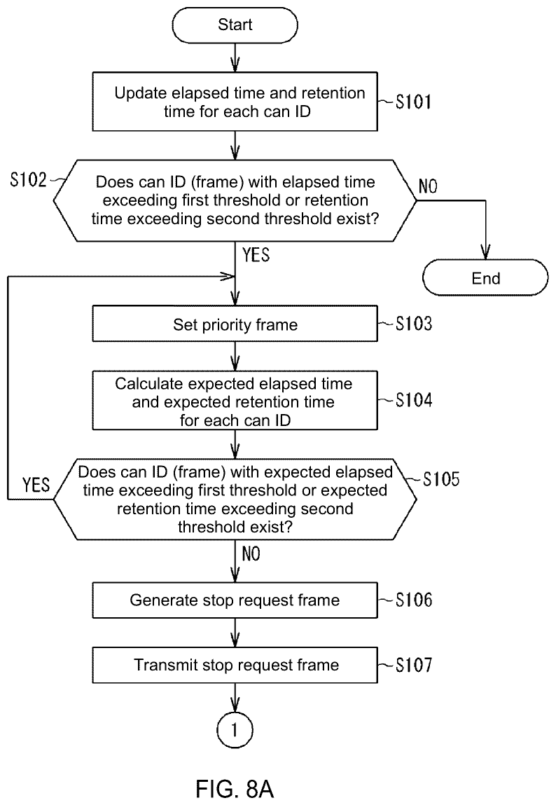

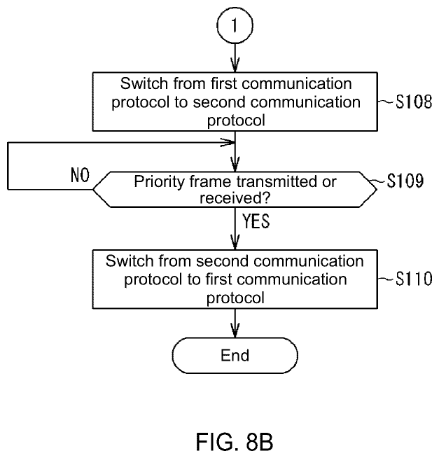

FIG. 8A and FIG. 8B are flowcharts depicting a communication control process performed by the relay ECU according to the present embodiment. This communication control process is executed at predetermined time intervals.

The processor 201 updates the elapsed time and retention time for each CAN ID in the management table 211 (step S101).

The processor 201 compares the elapsed time for each CAN ID with the first threshold and determines whether a CAN ID (frame) whose elapsed time exceeds the first threshold exists. The processor 201 also compares the retention time for each CAN ID with the second threshold and determines whether a CAN ID (frame) whose retention time exceeds the second threshold exists (step S102).

When there is no CAN ID whose elapsed time exceeds the first threshold and there is no CAN ID whose retention time exceeds the second threshold (NO in step S102), the processor 201 ends the communication control process.

If a CAN ID exists whose elapsed time exceeds the first threshold, or if a CAN ID exists whose retention time exceeds the second threshold (YES in step S102), the processor 201 determines the frame of the CAN ID whose elapsed time exceeds the first threshold, or the frame of the CAN ID whose retention time exceeds the second threshold, as a priority frame (step S103).

The processor 201 calculates the expected elapsed time and expected retention time for each CAN ID (excluding the CAN IDs of the priority frames) (step S104). When doing so, for CAN IDs for which a retention time has not been registered in the management table 211, the expected retention time is not calculated.

The processor 201 compares the expected elapsed time for each CAN ID with the first threshold and determines whether a CAN ID (frame) whose expected elapsed time exceeds the first threshold exists. The processor 201 also compares the expected retention time for each CAN ID with a second threshold and determines whether a CAN ID (frame) whose expected retention time exceeds the second threshold exists (step S105).

If a CAN ID whose expected elapsed time exceeds the first threshold exists, or if a CAN ID whose expected retention time exceeds the second threshold exists (YES in step S105), the processor 201 returns to step S103 and determines a frame with the CAN ID whose expected elapsed time exceeds the first threshold, or a frame with the CAN ID whose expected retention time exceeds the second threshold, as a priority frame.

When executing step S104 again, the processor 201 calculates, for each CAN ID (excluding the CAN IDs of the priority frames), the expected elapsed time and expected retention time due to the newly added priority frame. In other words, the processor 201 calculates the transmission time of the newly added priority frame, and adds the calculated transmission time and the interval between frames to the expected elapsed times and expected retention times to calculate new expected elapsed times and a new expected retention times.

If there is no CAN ID whose expected elapsed time exceeds the first threshold and there is no CAN ID whose expected retention time exceeds the second threshold (NO in step S105), the processor 201 generates a stop request frame (step S106). The processor 201 then transmits the generated stop request frame (step S107).

The processor 201 switches from the first communication protocol to the second communication protocol (step S108).

The processor 201 determines whether a priority frame has been transmitted or received (step S109). If the relay ECU 200 is the transmission source of priority frames, the processor 201 determines whether the priority frames have been transmitted. If the ECU 300 is not the transmission source of the priority frames, the processor 201 determines whether the priority frames have been received.

When the relay ECU 200 has neither transmitted nor received a priority frame (NO in step S109), the processor 201 executes step S109 again.

When the relay ECU 200 has transmitted or received a priority frame (YES in step S109), the processor 201 switches from the second communication protocol to the first communication protocol (step S110). This ends the communication control process.

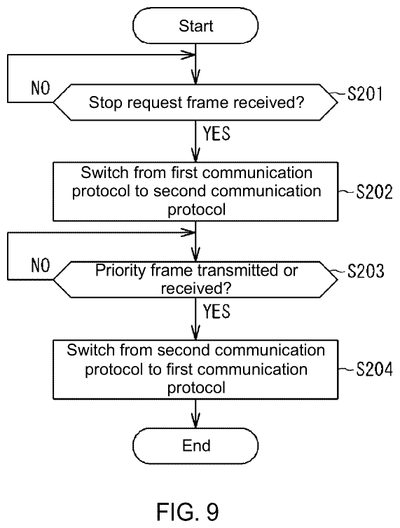

FIG. 9 is a flowchart depicting a communication process performed by an ECU according to the present embodiment.

The processor 301 determines whether a stop request frame has been received (step S201).

When a stop request frame has not been received (NO in step S201), the processor 301 executes step S201 again.

When a stop request frame has been received (YES in step S201), the processor 301 switches from the first communication protocol to the second communication protocol (step S202).

The processor 301 determines whether a priority frame has been transmitted or received (step S203). If that ECU 300 is the transmission source of a priority frame, the processor 301 determines whether the priority frame has been transmitted. If that ECU 300 is not the transmission source of a priority frame, the processor 301 determines whether a priority frame has been received.

When the ECU 300 has not transmitted and has not received a priority frame (NO in step S203), the processor 301 executes step S203 again.

When the ECU 300 has transmitted or received a priority frame (YES in step S109), the processor 301 switches from the second communication protocol to the first communication protocol (step S204). This ends the communication process.

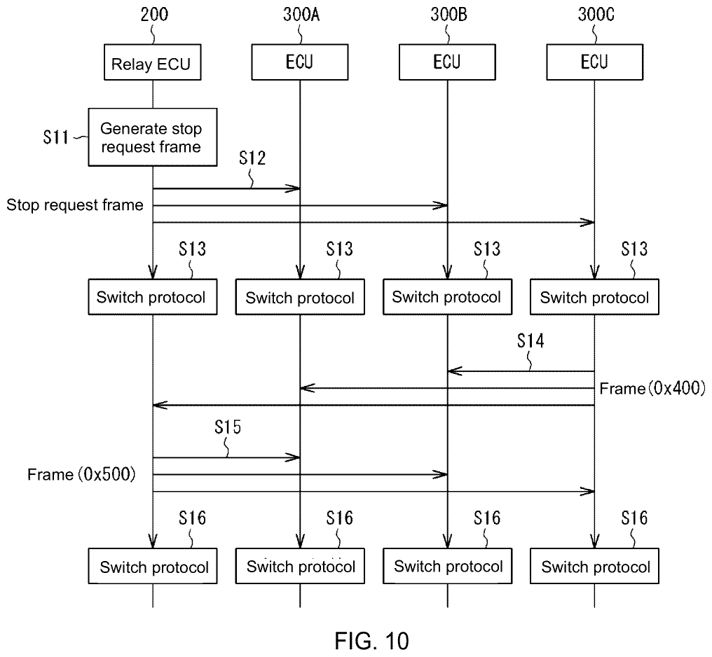

FIG. 10 is a sequence chart depicting an example operation of the vehicle-mounted system according to the present embodiment. FIG. 10 depicts the operation from a stage where the relay ECU 200 generates a stop request frame.

It is assumed that a frame with the CAN ID 0x400 and a frame with the CAN ID 0x500 have been determined as priority frames. The relay ECU 200 generates a stop request frame (step S11). The payload of this stop request frame contains the CAN IDs 0x400 and 0x500.

The relay ECU 200 transmits the stop request frame to the communication bus 400A (step S12). The ECUs 300A, 300B, and 300C receive this stop request frame.

The relay ECU 200 and the ECUs 300A, 300B, and 300C each switch from the first communication protocol to the second communication protocol (step S13).

The ECU 300C, to which the CAN ID 0x400 is assigned, transmits a frame (a priority frame) with the CAN ID 0x400 to the communication bus 400A(step S14). The relay ECU 200 and the ECUs 300A and 300B receive this frame with the CAN ID 0x400.

The relay ECU 200 that relays the CAN ID 0x500 transmits the frame (a priority frame) with the CAN ID 0x500 to the communication bus 400A (step S15). The ECUs 300A, 300B, and 300C receive this frame with the CAN ID 0x500.

The relay ECU 200 and the ECUs 300A, 300B, and 300C each switch from the second communication protocol to the first communication protocol (step S16).

### Modifications

Although a configuration where the relay ECU 200 stores the management table 211 and executes the communication control process to suppress frame delays has been described in the embodiment described above, the present disclosure is not limited to this. As one example, when communication on the communication bus 400A is controlled, it is possible for one of the ECUs 300A, 300B, and 300C to execute the communication control process. That is, an ECU 300 may be another example of a “communication apparatus” for the present disclosure. In this case, since it is not possible to manage the retention time of a frame at the relay ECU 200, the retention time and second threshold columns can be omitted from the management table 211. The ECU 300 in question can omit the processes of comparing retention times (or expected retention times) with the second threshold and setting priority frames when the retention times (or expected retention times) exceed the second threshold.

Although the relay ECU 200 manages the communication statuses of frames on a CAN ID basis using one management table 211 in the embodiment described above, the present disclosure is not limited to this. The management table 211 may be divided into a plurality of tables.

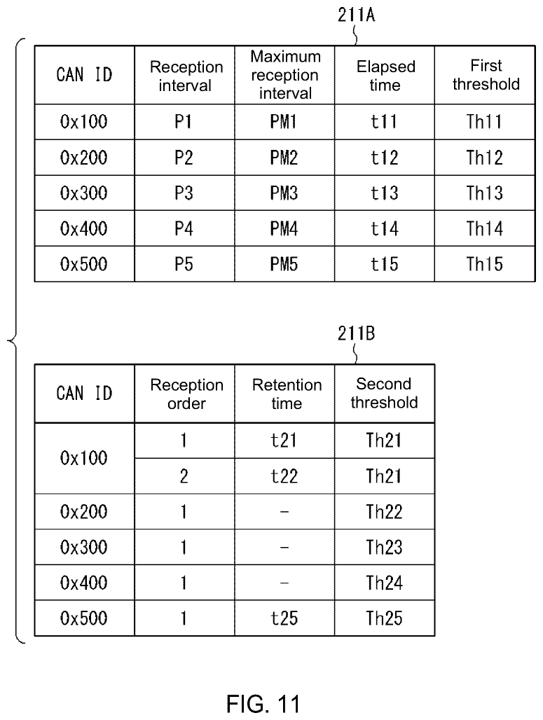

FIG. 11 is a diagram depicting a modification to the management table. FIG. 11 depicts a first management table 211A and a second management table 211B. The first management table 211A includes CAN ID, reception interval, maximum reception interval, elapsed time, and first threshold columns, and includes a record (that is, a row) for each CAN ID. In the first management table 211A, a reception interval, a maximum reception interval, a retention time, and a first threshold are registered for each CAN ID.

The second management table 211B includes CAN ID, reception order, retention time, and second threshold columns. A plurality of frames with the same CAN ID may be simultaneously retained at the relay ECU 200. Accordingly, the second management table 211B includes a record for each frame.

When the relay ECU 200 receives a frame, a record of that frame is added to the second management table 211B and when the relay ECU 200 transmits a frame, the record of that frame is deleted.

As one example, when a frame with the CAN ID 0x100 has been received, the relay ECU 200 adds a record for that frame to the second management table 211B. “1” is stored in the reception order field of this record. When another frame with the CAN ID 0x100 has been received while the frame mentioned above is being retained, the relay ECU 200 adds a record for the newly received frame to the second management table 211B. “2” is stored in the reception order field of this record.

In this way, it is possible to manage a plurality of frames with the same CAN ID that are retained at the relay ECU 200.

### APPENDIX

The embodiments disclosed above are exemplary in all respects and should not be regarded as limitations. The scope of the present disclosure is not limited to the embodiment given above, is indicated by claims, and is intended to include all changes within the meaning and scope of the claims and their equivalents.

1. A communication apparatus that controls communication on a communication path to which a plurality of vehicle-mounted apparatuses are connected, the communication apparatus comprising:
a determination unit that determines whether a transmission timing of a first frame, out of a scheduled plurality of frames to be transmitted on the communication path, exceeds a first delay time;
a generation unit that generates a stop request frame for requesting a stopping of transmission of frames when the determination unit has determined that the transmission timing of the first frame exceeds the first delay time;
a transmission unit that transmits the stop request frame generated by the generation unit to the plurality of vehicle-mounted apparatuses via the communication path; and
an estimation unit that estimates, when the determination unit has determined that the transmission timing of the first frame exceeds the first delay time, a transmission timing of a second frame whose transmission timing changes due to a change in a transmission order of the first frame,
wherein the determination unit determines whether the transmission timing of the second frame estimated by the estimation unit exceeds a second delay time, and
the generation unit generates, when the determination unit has determined that the transmission timing of the second frame exceeds the second delay time, the stop request frame for requesting a stopping of transmission of different frames aside from the first frame and the second frame until the first frame and the second frame have been transmitted on the communication path.

2. The communication apparatus according to claim 1, wherein the estimation unit estimates, as the transmission timing of the second frame, a timing produced by adding a time required for transmission of the stop request frame and the first frame to a transmission timing of the second frame before the transmission order of the first frame is changed.

3. The communication apparatus according to claim 1, wherein the generation unit generates, when the determination unit has determined that the transmission timing of the second frame exceeds the second delay time, the stop request frame including first identification information for identifying the first frame and second identification information for identifying the second frame.

4. The communication apparatus according to claim 3, wherein the stop request frame includes the first identification information and the second identification information in a transmission order of the first frame and the second frame.

5. The communication apparatus according to claim 1,
wherein the first delay time is set based on a first tolerated delay time, which is a tolerated delay time for the first frame, and one of a number of pieces of identification information of frames transmitted on the communication path, a number of the vehicle-mounted apparatuses connected to the communication path, and a transmission frequency of frames on the communication path, and
the second delay time is set based on a second tolerated delay time, which is a tolerated delay time for the second frame, and one of the number of pieces of identification information of frames transmitted on the communication path, the number of the vehicle-mounted apparatuses connected to the communication path, and the transmission frequency of frames on the communication path.

6. The communication apparatus according to claim 1,
wherein the first delay time is set based on whether a transmission source of the first frame is a vehicle-mounted apparatus connected to one communication path or a vehicle-mounted apparatus connected to a plurality of communication paths, and
the second delay time is set based on whether the transmission source of the second frame is a vehicle-mounted apparatus connected to one communication path or a vehicle-mounted apparatus connected to a plurality of communication paths.

7. The communication apparatus according to claim 1, wherein the communication apparatus is a relay apparatus that is connected to a plurality of communication paths and relays frames between the plurality of communication paths.

8. The communication apparatus according to claim 7,
wherein the determination unit also determines whether a retention time at the relay apparatus of the first frame transmitted from a first communication path to a second communication path out of the plurality of communication paths exceeds a threshold, and
the generation unit generates the stop request frame when the determination unit has determined that the transmission timing of the first frame exceeds the first delay time or that the retention time exceeds the threshold.

9. The communication apparatus according to claim 8,
wherein the estimation unit also estimates, when the second frame is a frame to be transmitted from the first communication path to the second communication path, a retention time of the second frame at the relay apparatus when a transmission order of the first frame has changed,
the determination unit also determines whether the retention time of the second frame estimated by the estimation unit exceeds the threshold, and
the generation unit generates, when the determination unit has determined that the transmission timing of the second frame exceeds the second delay time or the retention time of the second frame exceeds the threshold, the stop request frame for requesting a stopping of transmission of different frames aside from the first frame and the second frame until the first frame and the second frame have been transmitted on the communication path.

10. The communication apparatus according to claim 9, wherein the estimation unit estimates, as the retention time of the second frame, a time obtained by adding a time required for transmission of the stop request frame and the first frame to a retention time at the relay apparatus of the second frame before a transmission order of the first frame is changed.

11. The communication apparatus according to claim 1,
wherein the communication apparatus further includes a switching unit that switches between a first communication protocol and a second communication protocol that has a higher transmission speed than the first communication protocol, and
the switching unit switches from the first communication protocol to the second communication protocol during a period from when the stop request frame is transmitted until transmission of the first frame and the second frame is completed.

12. A communication control method that controls communication on a communication path to which a plurality of vehicle-mounted apparatuses are connected, the communication method comprising:
a step of determining whether a transmission timing of a first frame, out of a scheduled plurality of frames to be transmitted on the communication path, exceeds a first delay time;
a step of estimating, when it has been determined that the transmission timing of the first frame exceeds the first delay time, a transmission timing of a second frame whose transmission timing changes due to a change in a transmission order of the first frame;
a step of determining whether the estimated transmission timing of the second frame exceeds a second delay time;
a step of generating, when it has been determined by the determination unit that the transmission timing of the second frame exceeds the second delay time, a stop request frame for requesting a stopping of transmission of different frames aside from the first frame and the second frame until the first frame and the second frame have been transmitted on the communication path; and
a step of transmitting the generated stop request frame via the communication path to the plurality of vehicle-mounted apparatuses.

13. A communication control program for controlling communication on a communication path to which a plurality of vehicle-mounted apparatuses are connected,
the communication control program causing a computer to execute a process comprising:
a step of determining whether a transmission timing of a first frame, out of a scheduled plurality of frames to be transmitted on the communication path, exceeds a first delay time;
a step of estimating, when it has been determined that the transmission timing of the first frame exceeds the first delay time, a transmission timing of a second frame whose transmission timing changes due to a change in a transmission order of the first frame;
a step of determining whether the estimated transmission timing of the second frame exceeds a second delay time;
a step of generating, when it has been determined by the determination unit that the transmission timing of the second frame exceeds the second delay time, a stop request frame for requesting a stopping of transmission of different frames aside from the first frame and the second frame until the first frame and the second frame have been transmitted on the communication path; and
a step of transmitting the generated stop request frame via the communication path to the plurality of vehicle-mounted apparatuses.
